(19) United States
(12) Patent Application Publication
(10) Pub. No.: US 2016/0327389 A1
(43) Pub. Date: Nov. 10, 2016

(54) Calibration Transfer Between Two Devices

(71) Applicant: GoPro, Inc., San Mateo, CA (US)

(72) Inventor: Nenad Uzunovic, San Mateo, CA (US)

(21) Appl. No.: 15/147,752

(22) Filed: May 5, 2016

Related U.S. Application Data
(60) Provisional application No. 62/157,877, filed on May 6, 2015.

(51) Int. Cl. G01C 17/38; H04L 29/08

(52) U.S. Cl. CPC G01C 17/38; H04L 67/12

(57) ABSTRACT

Disclosed is a system to automatically calibrate a compass (e.g., a compass with a magnetometer) of an aerial vehicle. Auto calibration may occur at power up of the aerial vehicle or shortly thereafter. The system may be configured to rotate a gimbal, coupled with the aerial vehicle, in a wide range of rotational angles. The system may calibrate, in response to the rotations, a compass of the gimbal to obtain one or more calibration values and transfers the one or more calibration values to the aerial vehicle. The system may add a calibration difference value to the calibration value to obtain an adjusted calibration and may store the adjusted calibration for use with the compass of the aerial vehicle.

### CROSS REFERENCE TO RELATED APPLICATIONS

This application claims the benefit of U.S. Patent Application No. 62/157,877, filed May 6, 2015, the contents of which are incorporated by reference in its entirety.

### BACKGROUND

1. Field of Art

The disclosure generally relates to compasses and in particular to automatically calibrating a compass in an aerial vehicle based on the calibration of the compass in a gimbal.

2. Description of Art

Remote controlled devices with image capture devices (e.g., cameras and/or video cameras) mounted upon those devices are well known. For example, a remote control road vehicle can be configured to mount an image capture device on it to capture images as the vehicle is moved about remotely by a user. Similarly, remote controlled aerial vehicles, e.g., quadcopters, have been mounted with image capture devices to capture aerial as a user remotely controls the vehicle.

An issue with flying aerial vehicles is a lack of compass calibration. A miscalibrated magnetometer in a compass may be a cause of vehicle disorientations when flying the aerial vehicle. Hence, calibration is recommended before flight if the aerial vehicle was transported to an area with a different magnetic field. Despite this recommendation, magnetometer compass calibration is commonly forgotten. Moreover, when it is remembered, the calibration process is not a user-friendly process. It requires the user to manipulate the entire platform, i.e., the entire aerial vehicle, in a wide range of motion. This may be a time consuming and cumbersome process, which may cause users to ultimately skip the process or at least not perform it thoroughly.

### BRIEF DESCRIPTION OF THE DRAWINGS

The disclosed embodiments have advantages and features which will be more readily apparent from the detailed description, the appended claims, and the accompanying figures (or drawings). A brief introduction of the figures is below.

FIG. 1 illustrates an example configuration of remote controlled aerial vehicle in communication with a remote controller.

FIG. 2 illustrates an example of a remote controlled aerial vehicle.

FIG. 3 illustrates an example of a remote controlled aerial vehicle electronics and control systems.

FIG. 4A illustrates an example interconnect architecture of a remote controlled aerial vehicle with a gimbal.

FIG. 4B illustrates a flow diagram for an example automatic compass calibration process.

FIG. 5 illustrates a block diagram of an example camera architecture.

FIG. 6 illustrates a block diagram of an example remote control system of a remote controller.

FIG. 7 illustrates a functional block diagram of an example flight plan control system for a remote controller.

FIG. 8 illustrates a functional block diagram of an example flight plan control system for a remote controlled aerial vehicle.

FIG. 9 illustrates a flow diagram for an example program path operation on a remote controller.

FIG. 10 illustrates a flow diagram for an example program path operation load on a remote controlled aerial vehicle.

FIG. 11 illustrates a flow diagram for an example program path operation on a remote controlled aerial vehicle.

FIG. 12 illustrates a flow diagram for an example return path operation on a remote controlled aerial vehicle.

FIG. 13 illustrates an example user interface for a remote controller.

FIG. 14 illustrates an example machine for use with a system of the remote controlled aerial vehicle.

### DETAILED DESCRIPTION

The Figures (FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### Configuration Overview

Disclosed by way of example embodiments is a remote controlled aerial vehicle with camera and mounting configuration. The remote controlled aerial vehicle may include a mounting structure that secures an image capture device. The mounting structure may be removably attachable with an aerial vehicle. Moreover, the image capture device may be configured so that it may be removably attachable from the mounting structure. The mounting structure when removed from the aerial vehicle also can operate as a standalone mount.

In one embodiment, the mounting structure may include a mounting structure that may include a three-axis gimbal (for roll, pitch and yaw motion). An image capture device couples with this gimbal. When coupled with an image capture device, the gimbal may be capable of rotating the camera in all directions. The gimbal also may be capable of precisely measuring angles. The gimbal may include a compass with one or more magnetometers. In addition, the gimbal base may include an inertial measurement unit (IMU) sensor. The aerial vehicle may also include an IMU sensor. When coupled with the aerial vehicle, the gimbal may be configured to transfer magnetometer calibration values from the gimbal to the aerial vehicle.

Also disclosed is a configuration for a remote controlled aerial vehicle to have a route (e.g., a flight path) programmed into the remote controlled aerial vehicle and then executed during operation of the vehicle. In operation, the vehicle may monitor operational, mechanical, and environmental configurations to determine whether the vehicle can continue on the route, make adjustments or return to a predefined location. This configuration may include automating the process of flight adjustments and returns so that the remote controlled aerial vehicle may be able to operate with minimal to no impact on its immediate surroundings. Moreover, the return flight path benefits from the properly calibrated compass on the aerial vehicle. For example, if a condition detected by the aerial vehicle triggers it to automatically return via execution of a return path program, the aerial vehicle may rely on its now automated guidance system (which includes the properly calibrated magnetometer compass) to follow the specific return path programmed without need for having human intervention to make course adjustments, e.g., relating to directionality.

### Example System Configuration

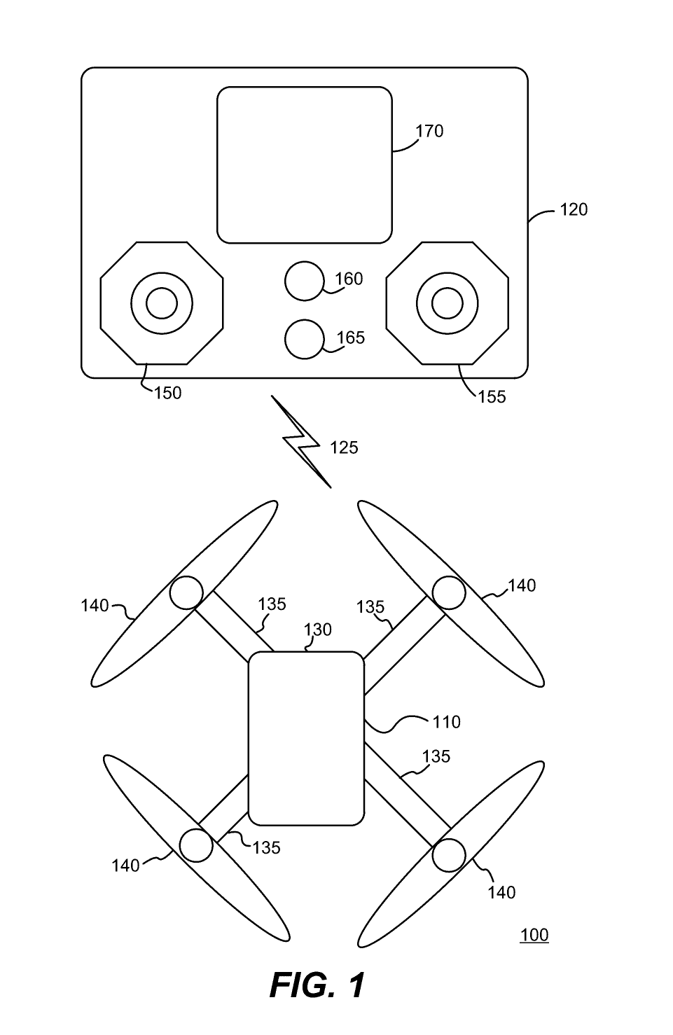

Turning now to FIG. 1, it illustrates an example configuration 100 of a remote controlled aerial vehicle 110 in communication with a remote controller 120. The configuration 100 includes a remote controlled aerial vehicle (“aerial vehicle”) 110 and a remote controller 120. The aerial vehicle 110 and the remote controller 120 may be communicatively coupled through a wireless link 125. The wireless link may be a wireless local area network (e.g., Wi-Fi), cellular (e.g., long term evolution (LTE), 3G, 4G, 5G), and/or other wireless communication link. The aerial vehicle 110 may be, for example, a quadcopter or other multirotor helicopter.

The aerial vehicle 110 in this example may include a housing 130 for a payload (e.g., electronics, storage media, and/or camera), two or more arms 135, and two or more propellers 140. Each arm 135 may mechanically couple with a respective thrust motor that couples a propeller 140 to create a rotary assembly. When the rotary assembly is operational, the propellers 140 spin at appropriate speeds and directions to allow the aerial vehicle 110 to lift (take off), land, hover, and move (forward, backward) in flight.

The remote controller 120 in this example includes a first control panel 150 and a second control panel 155, an ignition button 160, a return button 165 and a screen 170. A first control panel, e.g., 150, may be used to control “up-down” direction (e.g. lift and landing) of the aerial vehicle 110. A second control panel, e.g., 155, may be used to control “forward-reverse” direction of the aerial vehicle 110. Each control panel 150, 155 may be structurally configured as a joystick controller and/or touch pad controller. The ignition button 160 may be used to start the rotary assembly (e.g., start the respective thrust motors coupled with the propellers 140). The return (or come home) button 165 may be used to override the controls of the remote controller 120 and transmit instructions to the aerial vehicle 110 to return to a predefined location as further described herein. The ignition button 160 and the return button 165 may be mechanical and/or solid state press sensitive buttons. In addition, each button may be illuminated with one or more light emitting diodes (LED) to provide additional details. For example, an LED of the ignition button 160 may switch from one visual state to another to indicate whether the aerial vehicle 110 is ready to fly (e.g., lit green) or not (e.g., lit red). Also, an LED of the return button 165 may switch between visual states to indicate whether the aerial vehicle 110 is now in an override mode on return path (e.g., lit yellow) or not (e.g., lit red). It also is noted that the remote controller 120 may include other dedicated hardware buttons and switches and those buttons and switches may be solid state buttons and switches.

The remote controller 120 may also include a screen (or display) 170. The screen 170 may provide for visual display. The screen 170 may be a touch sensitive screen. The screen 170 also may be, for example, a liquid crystal display (LCD), an LED display, an organic LED (OLED) display, and/or a plasma screen. The screen 170 may allow for display of information related to the remote controller 120, such as menus for configuring the remote controller 120 and/or remotely configuring the aerial vehicle 110. The screen 170 also may display images captured from an image capture device coupled with the aerial vehicle 110.

### Remote Controlled Aerial Vehicle

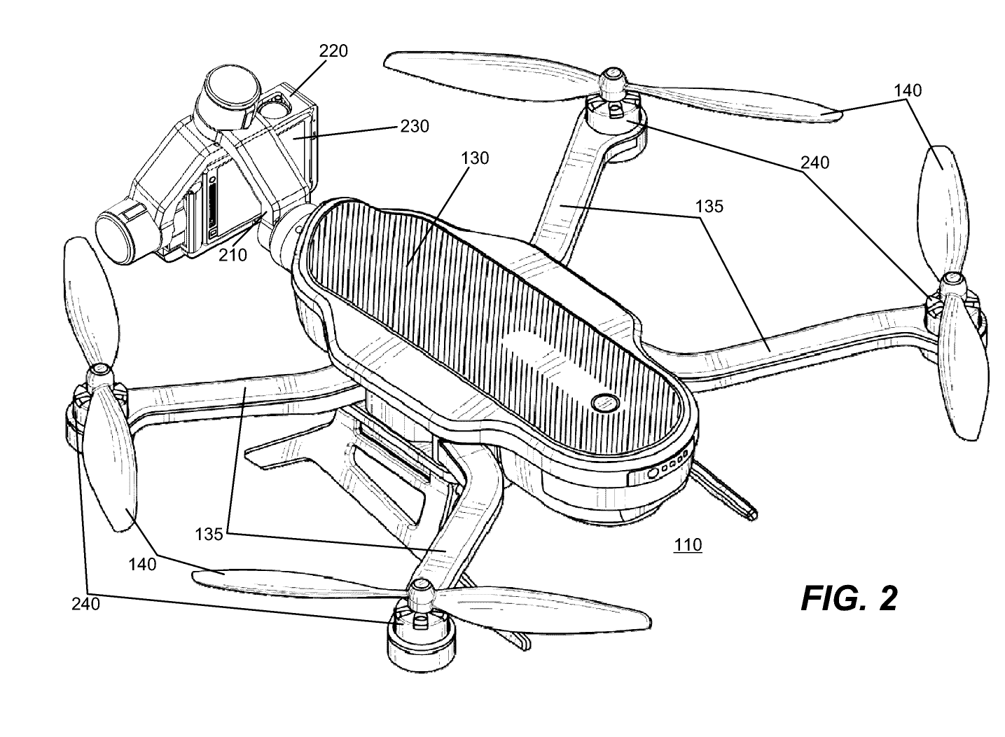

Referring now to FIG. 2, it illustrates an example embodiment of the remote controlled aerial vehicle 110. The remote controlled aerial vehicle 110 in this example is shown with the housing 130 and arms 135 of the arm assembly. In addition, this example embodiment shows a thrust motor 240 coupled with the end of each arm 130 of the arm assembly, a gimbal 210, a camera frame 220, and a camera 230. The thrust motor 240 couples with the propellers 140 to spin the propellers 140 when the thrust motors 240 are operational.

The gimbal 210 may be configured to allow for rotation of an object about an axis. The gimbal 210 may be a 3-axis gimbal 210 with three motors, each corresponding to a respective axis. Here, the object that the gimbal 210 rotates is a camera 230 coupled to camera frame 220 to which the gimbal 210 is mechanically coupled. The gimbal 210 and the camera frame 220 may form a mounting structure and when coupled together the entire assembly may be referenced as a gimbal 210 for ease of discussion. The camera frame 220 may be configured to allow the camera 230 to detachably couple (e.g., attach) to it and may include electrical connection points for the coupled camera 230. The gimbal 210 may allow for the camera frame 220 to maintain a particular position and/or orientation so that the camera 230 mounted to it can remain steady as the aerial vehicle 110 is in flight. In some embodiments, the camera frame 220 may be integrated into the gimbal 210 as a camera mount. In some embodiments, the camera frame 220 may be omitted and the gimbal 210 couples electronically and mechanically to the camera 230.

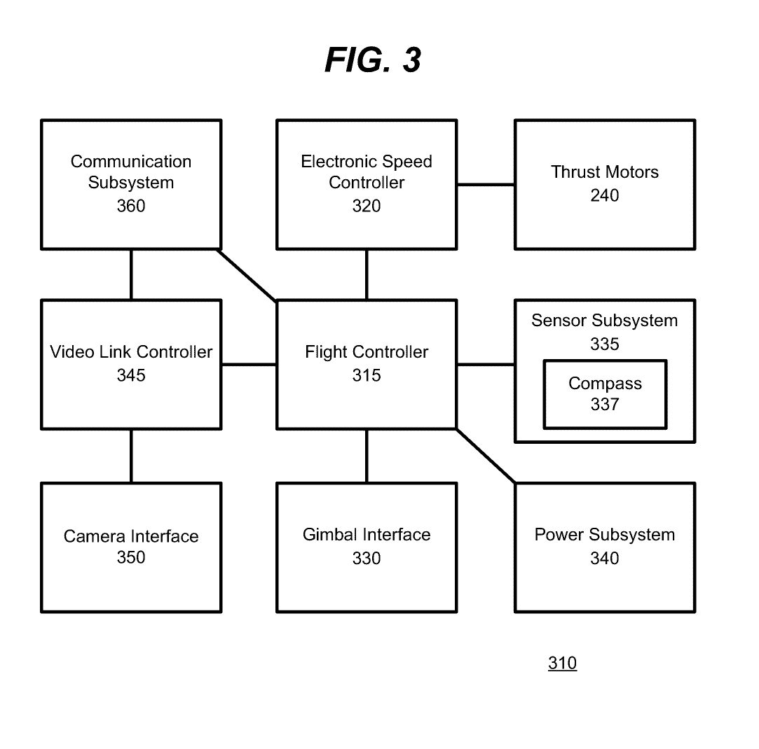

FIG. 3 illustrates an example embodiment of an electronics and control (EC) system 310 of the aerial vehicle 110. The EC system 310 may include a flight controller 315, an electronic speed controller 320, one or more thrust motors 240, a gimbal interface 330, a sensor (or telemetric) subsystem 335, a power subsystem 340, a video link controller 345, a camera interface 350, and a communication subsystem 360. The components may communicate directly or indirectly with each other through a data bus on the aerial vehicle 110.

In one embodiment, the communication subsystem 360 may be a long-range Wi-Fi system. It also may include or be another wireless communication system, for example, one based on long term evolution (LTE), 3G, 4G, and/or 5G mobile communication standards. The communication subsystem 360 also may be configured with a unidirectional RC channel for communication of controls from the remote controller 120 to the aerial vehicle 110 and a separate unidirectional channel for video downlink from the aerial vehicle 110 to the remote controller 120 (or to a video receiver where direct video connection may be desired). The sensor subsystem 335 may include navigational components, for example, a gyroscope, accelerometer, a global positioning system (GPS) and/or a barometric sensor. The telemetric compass may also include an unmanned aerial vehicle (UAV) compass 337. The UAV compass 337 may include one or more magnetometer sensors with which it determines the orientation of the aerial vehicle 110. The power subsystem 340 may include a battery pack and/or a protection circuit module as well as a power control and/or battery management system. The camera interface 350 may interface with an image capture device (e.g., camera 230) or may include an integrated image capture device. The integrated image capture device may be positioned similarly to the camera frame 220.

The flight controller 315 of the EC system 310 may communicate with the remote controller 120 through the communication subsystem 360. The flight controller 315 may control the flight related operations of the aerial vehicle 110 by controlling the other components such as the electronic speed controller 320 and/or the sensor subsystem 335. The flight controller 315 may interface with the gimbal control 420 to control the gimbal 210. The flight controller may interface with the gimbal controller 420 of the gimbal 210 through the gimbal interface 330. The flight controller 315 also may interface with the video link controller 345 for operation control of an image capture device (e.g., camera 230) coupled to the aerial vehicle 110.

The electronic speed controller 320 may be configured to interface with the thrust motors 240 (via electronics interface) to control the speed and thrust applied to the propellers 140 of the aerial vehicle 110. The video link controller 345 may be configured to communicate with the camera interface 350 to capture and transmit images from an image capture device to the remote controller 120 (or other device with a screen such as a smart phone), e.g., via the communication subsystem 360. The video may be overlaid and/or augmented with other data from the aerial vehicle 110 such as the telemetric (or sensor) data from the sensor subsystem 335. The power subsystem 340 may be configured to manage and supply power each of the components of the EC system 310.

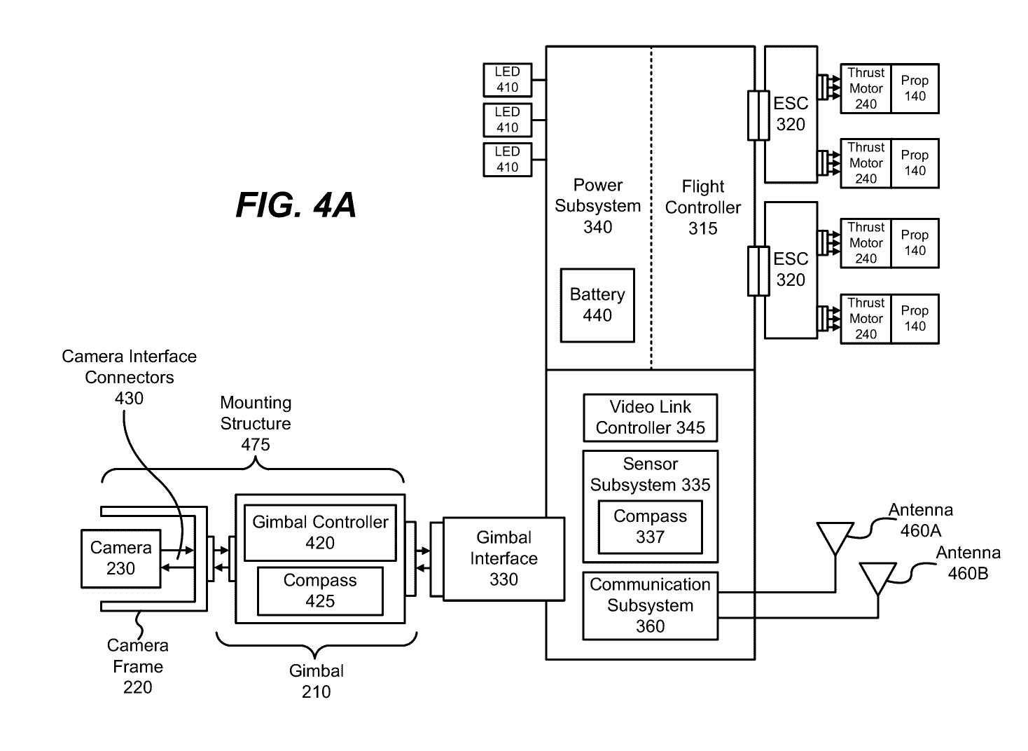

Turning to FIG. 4A, it illustrates an example interconnect architecture of the aerial vehicle 110 with the gimbal 210. This example embodiment may include the components illustrated and described in the prior figures, e.g., FIG. 3. Also shown are such as LEDs 410 on the aerial vehicle 110 that may be used to provide vehicle status related information. Also shown is a battery 440 as a part of the power subsystem 340 and two antennas 460A-460B as a part of the communication subsystem 360.

The figure illustrates in an example embodiment that the flight controller 315 may be coupled with two electronic speed controllers 320. Each electronic speed controller 320 in this configuration may drive two thrust motors 240 (via respective components of each thrust motor).

Also shown is a gimbal interface 330 that may communicatively couple the gimbal controller 420 to components of the EC system 310. In particular, the gimbal interface 330 may be communicatively coupled with the video link controller 345, the sensor subsystem 335 (e.g., the GPS and/or the compass), and/or one or more of the antennas 460A-460B. The gimbal interface 330 may be used to feed data (e.g., telemetric data, control signals received from the remote controller 120, and/or video link control signals) from the video link controller 345, the sensor subsystem 335, and/or one or more of the antennas 460A-460B to the gimbal controller 420. The gimbal controller 420 may use this data to adjust the camera frame 220. It is noted that the camera frame 220 may be, for example, a camera holder frame to secure a camera 230. The gimbal controller 420 may be communicative coupled with the camera 230 through one or more camera interface connectors 430. The camera interface connectors 430 may include camera communication interfaces such as universal serial bus (USB) and/or HDMI. The media captured by the camera 230 (e.g., still images, video, and/or audio) may be communicated to the aerial vehicle 110 through the camera interface connectors 430. Data (e.g., telemetric data from the sensor subsystem 335) also may be sent via the camera interface connectors 430 to the camera 230 to associate with video captured and stored on the camera 230.

In some embodiments, the gimbal interface 330 may perform functions attributed herein to the gimbal controller 420. For example, the gimbal interface 330 may set a position for each motor in the gimbal 210 and/or determine a current position for each motor of the gimbal 210 based on signals received from one or more rotary encoders.

### Automatic Compass Calibration

In one example aspect, the remote controlled aerial vehicle 110 includes a mounting structure 475. In one example embodiment, the mounting structure 475 may be removably attachable with the aerial vehicle 110 and may be structured to operate as a standalone mount. Continuing with the example embodiment, the mounting structure 475 may include a three-axis gimbal (e.g., gimbal 210) and a camera frame 220. The three-axis (e.g., x, y, and z axis) gimbal (e.g., gimbal 210) may include the gimbal controller 420, a gimbal compass 425, and/or an inertial measurement unit (IMU) sensor. The camera frame 220 may secure a camera, e.g., the camera 230.

When a camera (e.g., camera 230) couples with the mounting structure 475, the gimbal controller 420 may be able to rotate the attached camera 230 in all directions. The gimbal controller 420 may be capable of precisely measuring rotational angles (e.g., roll, pitch and yaw). The gimbal 210 may include a gimbal compass 425 (e.g., a compass with one or more magnetometer sensors). The aerial vehicle 110 also may include a UAV compass 337 and/or an IMU sensor. When coupled with the aerial vehicle 110, the gimbal compass 425 and the UAV compass 337 may interact for calibration. An IMU in the gimbal 210 and an IMU in the aerial vehicle 110 may also interact for calibration of the UAV compass 337.

It is noted that in an alternate aspect, the gimbal 210 may use rotary encoders (rotary encoders are, for example, conductive, optical, and/or magnetic) in addition to, or rather than, an IMU sensor. For example, when coupled with the aerial vehicle 110, readings from the gimbal compass 425, IMU, and/or rotary encoders from gimbal axes may be compared with UAV compass 337 and IMU readings of the aerial vehicle 110 for calibration as further described below.

The gimbal compass 425 and the UAV compass 337 may each include a respective magnetometer that can measure magnetic field in three dimensions. Values read from a magnetometer may be represented as (Mₓ, M_{y}, M_{z}). When rotated in all directions, magnetometer measurements ideally describe a sphere centered at (0, 0, 0). That is, suppose a compass is placed in a constant magnetic field but is otherwise not in the presence of interference. If the magnetic field at the location of the compass is represented by a polar coordinate vector B=(∥B∥, θ, φ) where ∥B∥ is the magnitude of the magnetic field (e.g., in Tesla) and θ and φ are angles specifying the direction of the field (e.g., 0°≦θ, φ<360°), then the compass, when rotated to any orientation (θ′, φ), will measure a magnetic field of B′=(∥B∥, θ+θ′, φ+φ′). Thus, the compass, when rotated to every direction, may measure a “sphere” centered (0,0,0) in Cartesian coordinates with a radius of ∥B∥.

Compasses (e.g., the gimbal compass 425 and/or the UAV compass 337) may be calibrated for hard-iron and/or soft-iron interference. Hard-iron interference may be caused by permanent magnets or magnetized iron/steel that are in the vicinity of the magnetometer of a compass. Hard-iron interference may be caused be external sources. Hard-iron interference may shift the center of the sphere described by (Mₓ, M_{y}, M_{z}) measurements away from (0, 0, 0). Soft-iron interference may be caused by internal factors such as current carrying traces on a printed circuit board (PCB) that includes the magnetometer. Soft-iron interference distorts the sphere where full round rotation circles have ellipsoidal shape.

The relationship between the normalized (calibrated) values (Mₓₙ, M_{yn}, M_{zn}) and raw sensor measurements (Mₓ, M_{y}, M_{z}) may be expressed as follows:

$$\begin{matrix}[ \begin{matrix}{M}_{xn} \\ {M}_{yn} \\ {M}_{zn}\end{matrix} ] = {{[ {M}_{m} ]}_{3 \times 3} [ \begin{matrix}\frac{1}{{M}_{scx}} & 0 & 0 \\ 0 & \frac{1}{{M}_{scy}} & 0 \\ 0 & 0 & \frac{1}{{M}_{scz}}\end{matrix} ] [ {M}_{si} ]}_{3 \times 3} [ \begin{matrix}{M}_{x} - {M}_{osx} \\ {M}_{y} - {M}_{osy} \\ {M}_{z} - {M}_{osz}\end{matrix} ] \\ = [ \begin{matrix}{MR}_{11} & {MR}_{12} & {MR}_{13} \\ {MR}_{21} & {MR}_{22} & {MR}_{23} \\ {MR}_{31} & {MR}_{32} & {MR}_{33}\end{matrix} ] [ \begin{matrix}{M}_{x} - {MR}_{10} \\ {M}_{y} - {MR}_{20} \\ {M}_{z} - {MR}_{30}\end{matrix} ]\end{matrix}$$

Here, M_{sck} may be scale factors, Mₒₛₖ are offsets for hard-iron distortion, and Mₛₖ may be a matrix that describes soft-iron distortion (k being x, y, or z). In one example aspect, a goal of compass calibration may be to describe MR₁₀ to MR₃₃ so that normalized values may be obtained from raw measurements. It is noted that an aerial vehicle may be designed to minimize soft-iron interference by placing magnetometers away from potential magnetic sources. Hence, the compasses may be calibrated for hard-iron interference using least squares sphere fitting based on a couple hundred measurements.

Continuing with a calibration process of the compass, in one example embodiment, magnetometer compass values may be initially factory calibrated. Factory calibration may involve mechanically locking two devices, e.g., the gimbal 210 (or mounting structure 475) and the aerial vehicle 110, and calibrating the compasses in a magnetically neutral environment. Both devices (e.g., the gimbal 210 and the aerial vehicle 110) may be taken through a wide range of motion during factory calibration. Once both devices are calibrated, the difference in calibration values between the two devices may be stored, e.g., in a memory storage of the aerial vehicle 110.

It is noted that a manual calibration step, similar to the factory calibration, may be needed after crashes and when self-checks fail. An automatic pre-flight check may be configured to detect calibration issues by comparing outputs of two or more magnetometer readings. A magnetometer on the gimbal 210 may be fixed in relation to a frame of the aerial vehicle 110 by manually setting all gimbal axes to the extreme angle (e.g., pushing them to hard stops).

When the aerial vehicle 110 is readied for flight, it may run an automated calibration process. For example, the aerial vehicle 110 coupled with the gimbal 210 may be placed at rest on a flat surface, e.g., flat ground. The gimbal 210 (or mounting structure 475) may undergo a wide range of angular motion (e.g., roll, pitch, and/or yaw rotation) via its axis motors controlled via the gimbal controller 420. These motions may be used to calibrate the gimbal compass 425. Once the gimbal compass 425 is calibrated, the calibration value may be copied (or transferred) over to the aerial vehicle 110. The aerial vehicle 110 may add in the previously stored calibration difference value from the factory calibration to obtain an adjusted calibration. The adjusted calibration may be saved in a storage, e.g., flash memory, in the aerial vehicle 110 as a current calibration value. The current calibration value may be used to operate the UAV compass 337.

As an additional check, the gimbal 210 may be automatically commanded to orient in such a way that gimbal compass 425 is aligned with the UAV compass 337. The values detected by the magnetometers (e.g., geographic directions, magnetic field directions, and/or magnetic field strengths) of the UAV and gimbal compasses 337, 425 may be directly compared to check if they match. A mismatch may provide an indication of a bad calibration. In such circumstances, a full manual calibration may be requested (e.g., by displaying an indication to a user on the screen 170 of the remote controller 120) to calculate new differences between the sensors.

By way of an example process, automatic calibration of the magnetometer compass may begin with a user powering up the aerial vehicle 110. Once powered, the gimbal 210 may rotate in a wide range of motion. The gimbal 210 may calibrate its internal gimbal compass 425. The aerial vehicle 110 may then receive calibration information from the gimbal 210 and may add in the pre-calculated difference obtained from the factory calibration value (i.e., the factory-defined calibration value). The aerial vehicle 110 may store the new calibration values in a storage, e.g., flash memory. The UAV compass 337 may now be considered calibrated for flight. The gimbal 210 may provide additional confirmation checks to ensure that the gimbal compass 425 of the gimbal 210 and/or the UAV compass 337 of the aerial vehicle 110 are aligned. Optionally, the aerial vehicle 110 may receive value associated with the alignment of the sensors of the UAV and gimbal compasses 337, 425 to compare against a previously saved value corresponding to the alignment for further confirmation that the calibration is correct. If the calibration is determined to not be correct, the aerial vehicle 110 may take further corrective action. In addition, the system may be configured to allow a user to check proper calibration through status information transmitted from the aerial vehicle 110 to the remote controller 120 for display on its screen 170 or by visual indicators, e.g., LED lights, on the aerial vehicle 110 and/or the remote controller 120.

Using the automatic compass calibration configuration described, an aerial vehicle 110 may be calibrated with minimal user effort. Unlike conventional configurations, the aerial vehicle 110 may not need to force a user to work through a wide range of motions in order to calibrate its compass at startup. Rather, the gimbal (e.g., gimbal 210) of the mounting structure 475 performs calibration motions through the gimbal controller 420 to automatically calibrate the gimbal compass 425 using the built-in motors of the gimbal 210. Once the gimbal compass 425 is calibrated, data derived during this calibration may be transferred to the aerial vehicle 110. The aerial vehicle 110 may add to the calibrated value the factory-calculated difference value so that the UAV compass 337 is now properly calibrated for flight. It is noted that in some embodiments, the factory-calculated difference value may be replaced by a user processed difference value. For example, a user may perform the initial or default calibration for use as the difference value.

FIG. 4B illustrates a flow diagram for an example automatic compass calibration method 450. The method 450 may start 455 with the gimbal 210 rotating 470 to an angular rotation. The gimbal 210 rotating 470 may include one or more commands being transmitted from the aerial vehicle 110 to the gimbal controller 420 through the gimbal interface 330. The gimbal compass 425 measures 475 (e.g., with one or more magnetometers of the gimbal compass 425) a magnetic field (e.g., the magnetic field of the earth) at the angular rotation. The measurement of the magnetic field may be stored in a memory of the gimbal 210 and/or the aerial vehicle 110 in association with the corresponding angular rotation.

After taking a magnetic field measurement, a loop condition may be checked 480. If the loop condition is first condition (i.e., condition A), then the loop may enter a next iteration. That is, if the loop condition is condition A, the gimbal 210 may rotate 470 to a new angular rotation and the gimbal compass 425 may measure 475 the magnetic field at this new angular rotation. Alternately, if the loop condition is condition B (i.e., a condition mutually exclusive with condition A), a next sequence of steps may be performed. In this way, the method 455 may take a plurality of measurements of a magnetic field before proceeding to the next sequence of steps. Each measurement of the magnetic field may correspond to a respective angular rotation of a plurality of angular rotations. Each angular rotation may be unique, though this need not be the case in every embodiment. Each angular rotation may correspond to a rotation of the three motors of the gimbal 210.

The loop condition check 480 may correspond to checking 480 a value of an iterated integer. That is, the method 450 may perform a predetermined number of iterations before moving on to the next step. In some embodiments, the loop condition may be based on a derived quality metric of the magnetic field measurements. For example, if the variation of measurements from a regression model is large the method 450 may perform more measurements (i.e., obtain a larger number of measurements) and conversely, if the measurements from the regression model is small the method 450 may perform fewer iterations (i.e., obtain fewer measurements). This regression model may be updated with each new measurement of the magnetic field. In some embodiments, the number of iterations may be based on the measured strength of the magnetic field. In some embodiments, the loop condition check 480 may be conditioned on an estimated probability that a calibration value should be within some range. In some embodiments, the loop condition check 480 may be conditioned on an estimated mean error and/or an estimated mean square error of an estimated calibration value.

After the measurements of the magnetic field have been obtained with the gimbal compass 425 (i.e., after the loop condition check 480 determines condition B), a calibration value for the gimbal compass 425 may be calculated 485. This calibration value or data derived therefrom may be transferred 490 (e.g., via the gimbal interface 330) to the aerial vehicle 110. The aerial vehicle 110 may add 495 a calibration difference value to the calibration value to obtain a current calibration value for the aerial vehicle 110. This current calibration value may be stored in a memory of the aerial vehicle 110. After this, the aerial vehicle 110 may be ready 465 for a next action (e.g., ready to lift off for flight). Subsequently, the aerial vehicle 110 may determine its orientation (e.g., relative to one or more cardinal directions) based on a measurement with the UAV compass 337 of the aerial vehicle 110 and based on the current calibration.

In some embodiments, the calibration difference value may be a factory-calculated calibration value. That is, the calibration difference value may be empirically derived for the aerial vehicle 110 via a calibration process performed prior to the aerial vehicle 110 being retailed. In some embodiments, the calibration difference value is a predetermined value. In some embodiments, the calibration difference value is a user-defined calibration value. That is, the calibration difference value may be input by a user into the remote controller 120 or uploaded from another device to the aerial vehicle 110.

In some embodiments, when the aerial vehicle 110 is ready 465, it transmits a signal to the remote controller 120 indicating completion of the automatic calibration. The remote controller 120 may display an indication that the automatic calibration has completed successfully and/or stop displaying an indication that the UAV compass 337 is being calibrated. In some embodiments, the aerial vehicle illuminates one or more LEDs (e.g., LEDs 410) as an indication of the completion of the automatic calibration. The LEDs may be on the aerial vehicle 110 and/or some other device (e.g., the remote controller 120). It some embodiments, the aerial vehicle 110 and/or the remote controller 120 emits audio (e.g., via a speaker) when the aerial vehicle 110 is ready 465.

### Example Camera Architecture

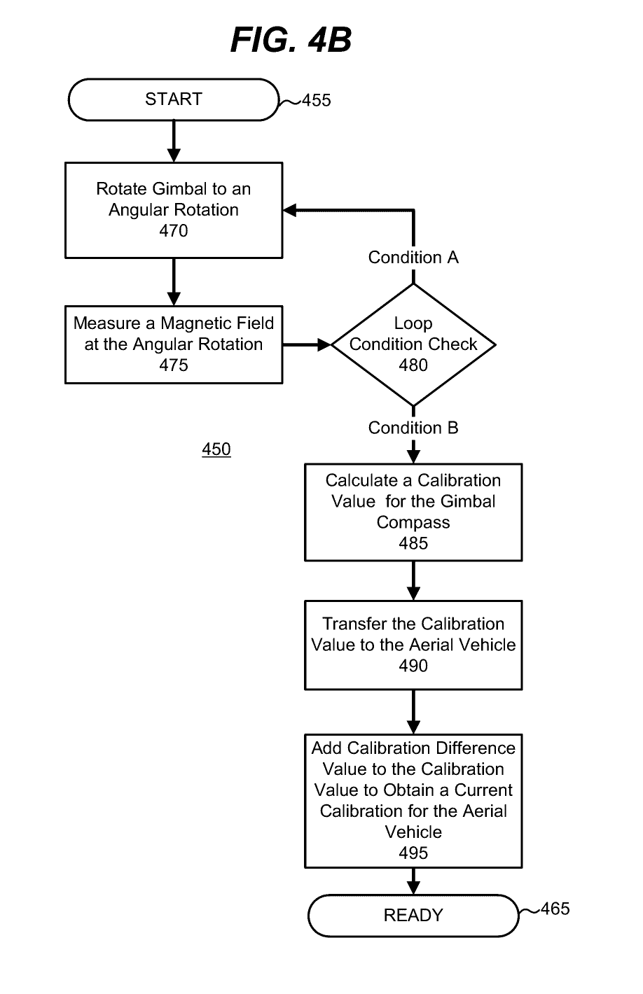

FIG. 5 illustrates a block diagram of an example camera architecture. The camera architecture 505 corresponds to an architecture for the camera, e.g., 230. Briefly referring back to the camera 230, it may include a camera body, one or more a camera lenses, various indicators on the camera body (such as LEDs and/or displays), various input mechanisms (such as buttons, switches, and touch-screen mechanisms), and electronics (e.g., imaging electronics, power electronics, and/or metadata sensors) internal to the camera body for capturing images via the one or more lenses and/or performing other functions. In one example embodiment, the camera 230 may be capable of capturing spherical or substantially spherical content. As used herein, spherical content may include still images or video having spherical or substantially spherical field of view. For example, in one embodiment, the camera 230 may capture video having a 360 degree field of view in the horizontal plane and a 180 degree field of view in the vertical plane. Alternatively, the camera 230 may capture substantially spherical images or video having less than 360 degrees in the horizontal direction and less than 180 degrees in the vertical direction (e.g., within 10% of the field of view associated with fully spherical content). In other embodiments, the camera 230 may capture images or video having a non-spherical wide angle field of view.

As described in greater detail below, the camera 230 may include sensors 540 to capture metadata associated with video data, such as timing data, motion data, speed data, acceleration data, altitude data and/or GPS data. In a particular embodiment, location and/or time centric metadata (e.g., geographic location, time, and/or speed) can be incorporated into a media file together with the captured content in order to track the location of the camera 230 over time. This metadata may be captured by the camera 230 itself or by another device (e.g., a mobile phone and/or the aerial vehicle 110 via the camera interface connectors 430) proximate to the camera 230. In one embodiment, the metadata may be incorporated with the content stream by the camera 230 as the spherical content is being captured. In another embodiment, a metadata file separate from the video file may be captured (by the same capture device or a different capture device) and the two separate files may be combined or otherwise processed together in post-processing. It is noted that these sensor 540 may be in addition to the sensors of the sensor subsystem 335. In embodiments in which the camera 230 is integrated with the aerial vehicle 110, the camera 230 may not have separate individual sensors 540, but may rather rely upon the sensor subsystem 335 integrated with the aerial vehicle 110 and/or sensors of the gimbal 210.

Referring now to the details of FIG. 5, it illustrates a block diagram of the camera architecture 505 of the camera 230, according to one example embodiment. In the illustrated embodiment, the camera 230 includes a camera core 510 that includes a lens 512, an image sensor 514, and an image processor 516. The camera 230 may include a system controller 520 (e.g., a microcontroller or microprocessor) that controls the operation and functionality of the camera 230. The camera 230 also may include a system memory 530 that is configured to store executable computer instructions that, when executed by the system controller 520 and/or the image processors 516, may perform the camera functionalities described herein. In some example embodiments, a camera 230 may include multiple camera cores 510 to capture fields of view in different directions which may then be stitched together to form a cohesive image. For example, in an embodiment of a spherical camera system, the camera 230 may include two camera cores 510 each having a hemispherical or hyper hemispherical lens that each captures a hemispherical or hyper hemispherical field of view which are stitched together in post-processing to form a spherical image.

The lens 512 may be, for example, a wide angle lens, hemispherical, and/or hyper hemispherical lens that focuses light entering the lens to the image sensor 514 which captures images and/or video frames. The image sensor 514 may capture high-definition images having a resolution of, for example, 720p, 1080p, 4k, or higher. In one embodiment, spherical video is captured as 5760 pixels by 2880 pixels frames with a 360 degree horizontal field of view and a 180 degree vertical field of view. For video, the image sensor 514 may capture video at frame rates of, for example, 30 frames per second, 60 frames per second, or higher. The image processor 516 may perform one or more image processing functions of the captured images or video. For example, the image processor 516 may perform a Bayer transformation, demosaicing, noise reduction, image sharpening, image stabilization, rolling shutter artifact reduction, color space conversion, compression, and/or other in-camera processing functions. Processed images and/or video may be temporarily or persistently stored to the system memory 530 and/or to another non-volatile storage, which may be in the form of internal storage or an external memory card.

An input/output (I/O) interface 560 may transmit and/or receive data from various external devices. For example, the I/O interface 560 may facilitate the receiving or transmitting video or audio information through one or more I/O ports. Examples of I/O ports or interfaces include USB ports, HDMI ports, Ethernet ports, and audio ports. Furthermore, embodiments of the I/O interface 560 may include one or more wireless ports that may accommodate wireless connections. Examples of wireless ports include Bluetooth, Wireless USB, and/or Near Field Communication (NFC). The I/O interface 560 also may include an interface to synchronize the camera 230 with other cameras or with other external devices, such as a remote control, a second camera, a smartphone, a client device, and/or a video server.

A control/display subsystem 570 may include various control and display components associated with operation of the camera 230 including, for example, LED lights, a display, buttons, microphones, and/or speakers. The audio subsystem 550 may include, for example, one or more microphones and/or one or more audio processors to capture and process audio data correlated with video capture. In one embodiment, the audio subsystem 550 may include a microphone array having two or microphones arranged to obtain directional audio signals.

The sensors 540 may capture various metadata concurrently with, or separately from, video capture. For example, the sensors 540 may capture time-stamped location information based on a global positioning system (GPS) sensor, and/or an altimeter. Other sensors 540 may be used to detect and capture the orientation of the camera 230 including, for example, an orientation sensor, an accelerometer, a gyroscope, or a compass (e.g., a magnetometer compass). Sensor data captured from the various sensors 540 may be processed to generate other types of metadata. For example, sensor data from the accelerometer may be used to generate motion metadata that may include velocity and/or acceleration vectors representative of motion of the camera 230.

Furthermore, sensor data from the aerial vehicle 110 and/or the gimbal 210 may be used to generate orientation metadata describing the orientation of the camera 230. Sensor data from a GPS sensor may provide GPS coordinates identifying the location of the camera 230, and an altimeter may measures the altitude of the camera 230. In one embodiment, the sensors 540 may be rigidly coupled to the camera 230 such that any motion, orientation or change in location experienced by the camera 230 is also experienced by the sensors 540. The sensors 540 furthermore may associates a time stamp representing when the data was captured by each sensor. In one embodiment, the sensors 540 automatically begin collecting sensor metadata when the camera 230 begins recording a video.

### Example Remote Control System

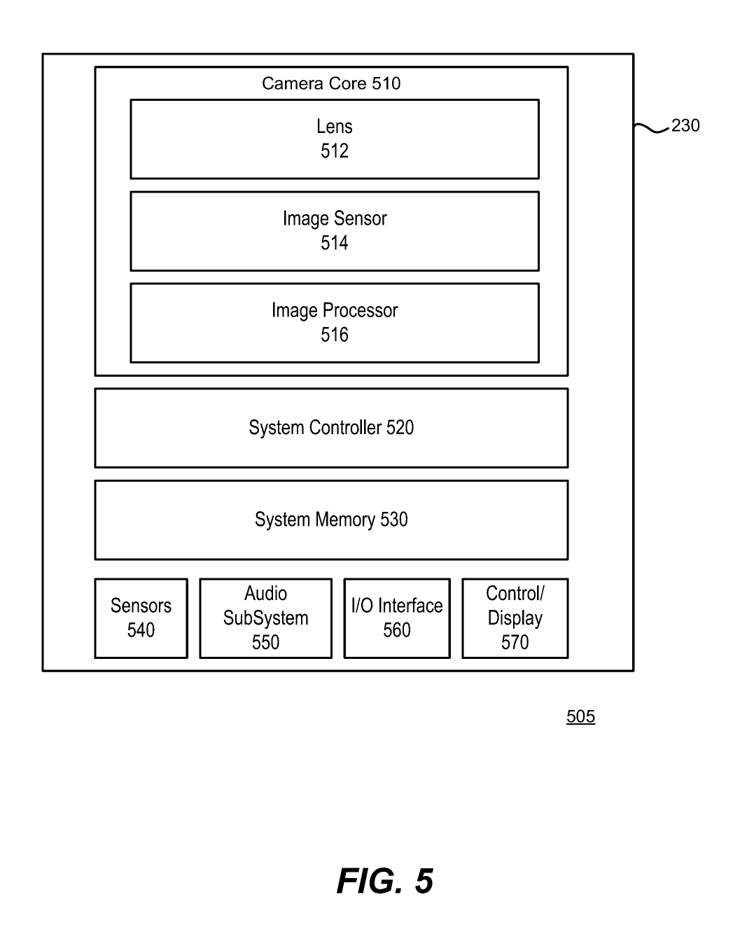

FIG. 6 illustrates a block diagram of an example remote control system 605 of a remote controller, e.g., remote controller 120. The remote control system 605 may include a processing subsystem 610, a navigation subsystem 620, an input/output (I/O) subsystem 630, a display subsystem 640, an audio/visual (A/V) subsystem 650, a control subsystem 660, a communication subsystem 670, and/or a power subsystem 680. The subsystems may be communicatively coupled through a data bus 690 and may be powered, where necessary, through the power subsystem 680.

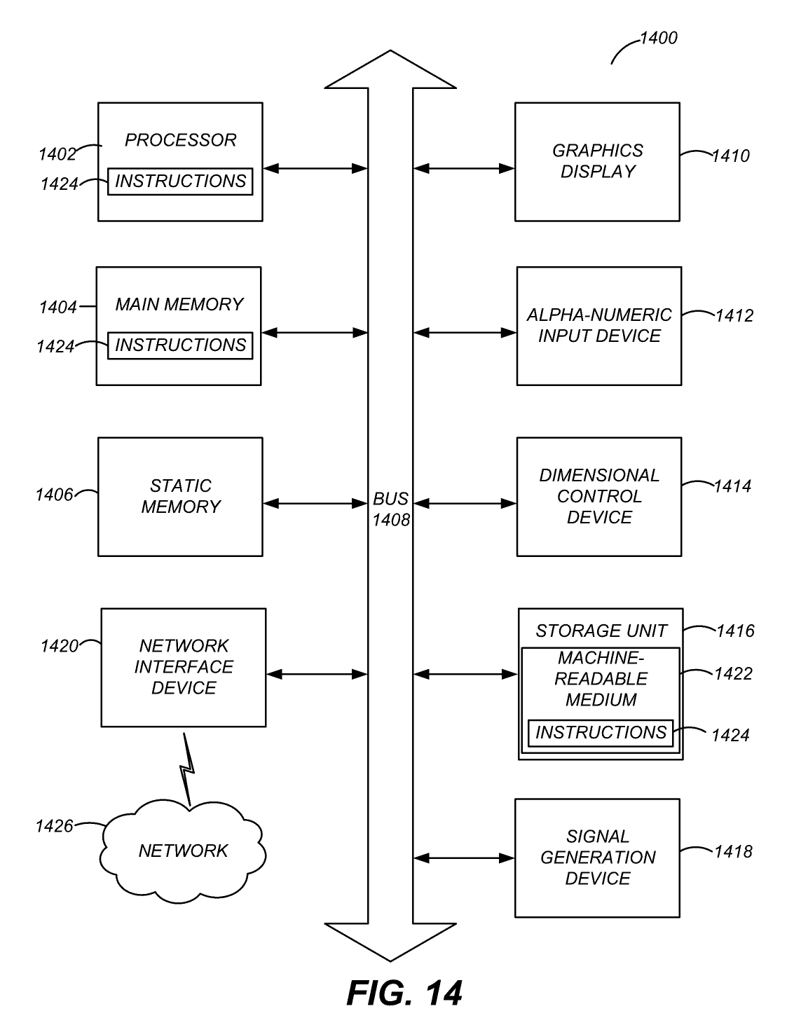

The processing subsystem 610 may be configured to provide the electronic processing infrastructure to execute firmware and/or software comprised of instructions. An example processing subsystem 610 is illustrated and further described in FIG. 14. The navigation subsystem 620 may include electronics, controls, and/or interfaces for navigation instrumentation for the remote controller 120. The navigation subsystem 620 may include, for example, a global position system (GPS) and a compass (e.g., a compass including a magnetometer). The GPS and compass may be used to track the location of the remote controller 120, which can be used to determine the position of the remote controller 120 relative to that of the aerial vehicle 110, and vice versa.

The I/O subsystem 630 may include the input and output interfaces and electronic couplings to interface with devices that allow for transfer of information into or out of the remote controller 120. For example, the I/O subsystem 630 may include a physical interface such as a universal serial bus (USB) or a media card (e.g., secure digital (SD)) slot. The I/O subsystem 630 also may be associated with the communication subsystems 670 to include a wireless interface such as Bluetooth. It is noted that in one example embodiment, the aerial vehicle 110 may use long-range Wi-Fi radio (or some other type of WLAN) via the communication subsystem 670, but also may use a second Wi-Fi radio or cellular data radio (as a part of the I/O subsystem 630) for connection to other wireless data enabled devices, for example, smart phones, tablets, laptop or desktop computers, and/or wireless internet access points. Moreover, the I/O subsystem 630 also may include other wireless interfaces, e.g., Bluetooth, for communicatively coupling to devices that are similarly wirelessly enabled for short-range communications.

The display subsystem 640 may be configured to provide an interface, electronics, and/or display drivers for the screen 170 of the remote controller 120. The Audio/Visual (A/V) subsystem 650 may include interfaces, electronics, and/or drivers for an audio output (e.g., headphone jack or speakers) as well as visual indicators (e.g., LED lighting associated with, for example, the buttons 160 and/or button 165).

The control subsystem 660 may include electronic and control logic and/or firmware for operation with the control panels 150, 155, buttons 160, 165, and other control mechanisms on the remote controller 120.

The communication subsystem 670 may include electronics, firmware and/or interfaces for communications. The communications subsystem 670 may include one or more of wireless communication mechanisms such as Wi-Fi (short and long-range), long term evolution (LTE), 3G, 4G, and/or 5G. The communication subsystem 670 also may include wired communication mechanisms such as Ethernet, USB, and/or HDMI.

The power subsystem 680 may include electronics, firmware, and/or interfaces for providing power to the remote controller 120. The power subsystem 680 may include direct current (DC) power sources (e.g., batteries), but also may be configured for alternating current (AC) power sources. The power subsystem 680 also may include power management processes for extending DC power source lifespan. It is noted that in some embodiments, the power subsystem 680 may include a power management integrated circuit and a low power microprocessor for power regulation. The microprocessor in such embodiments may be configured to provide very low power states to preserve battery, and may be able to wake from low power states from such events as a button press or an on-board sensor (like a hall sensor) trigger.

### Example Flight Plan Control System for Remote Controller

Turning now to preparing an aerial vehicle, e.g., aerial vehicle 110, for flight, the disclosed configuration may include mechanisms for programming the aerial vehicle 110 for flight through a remote controller, e.g., remote controller 120. The example, a flight plan may be uploaded to the aerial vehicle 110. In some embodiments, while the flight plan is being uploaded, the UAV compass 337 may be calibrated (e.g., via method 450). The flight plan may provide the aerial vehicle 110 with basic flight related parameters, while the remote controller 120 is used to provide overall control of the aerial vehicle 110.

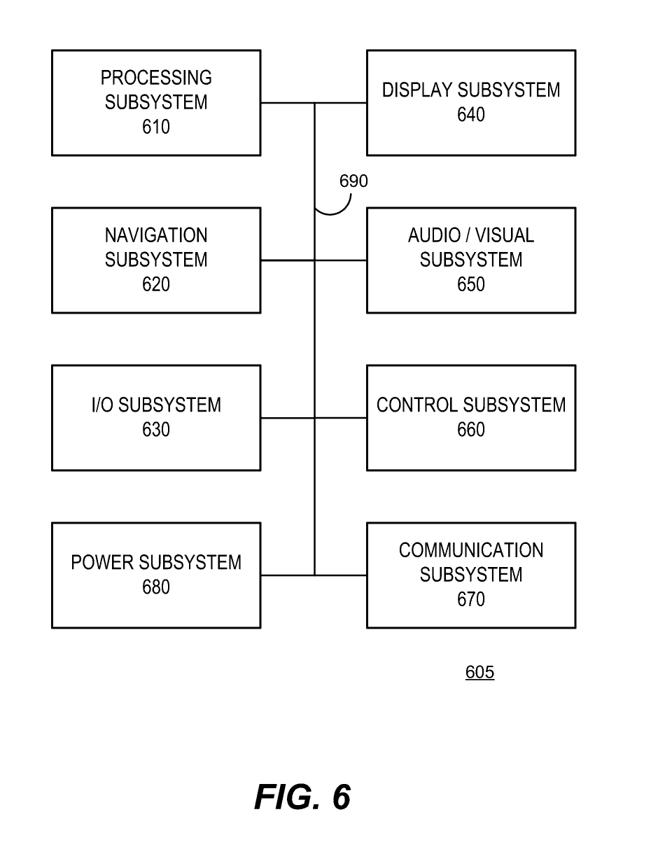

FIG. 7 illustrates a functional block diagram of an example flight plan control system 705 for a remote controller (e.g., remote controller 120). The system 705 may include a planning module 710, a route plan database 720, a route check module 730, an avoidance database 740, a system check module 750, and/or a return factors database 760. It is noted that the modules may be embodied as software (including firmware). The software may be program code (or software instructions) executable by the processing subsystem 610.

The flight plan control system 705 may be configured to provide flight (or route) planning tools that allow for preparing a flight plan of the aerial vehicle 110. The planning module 710 may include user interfaces displayed on the screen 170 of the remote controller 120 that allows for entering and viewing of information such as route (how and where the aerial vehicle 110 will travel), maps (geographic information over where the aerial vehicle 110 will travel), environmental condition data (e.g., wind speed and direction), terrain condition data (e.g., locations of tall dense shrubs), and/or other information necessary for planning a flight of the aerial vehicle 110.

The route plan database 720 may provide a repository (e.g., part of a storage device such as an example storage unit described with FIG. 14) for prepared flight plans to be stored. The route plan database 720 may also store plans that were previously created on the remote controller 120 and/or uploaded into it (e.g., through the I/O subsystem 630). The stored plans may be retrieved from the route plan database 720 and edited as appropriate through the planning module 710.

The route plan database 720 also may store preplanned (pre-programmed) maneuvers for the aerial vehicle 110 that may be retrieved and applied with a flight plan created through the planning module 710. For example, a “loop de loop” maneuver may be pre-stored and retrieved from the route plan database 720 and then applied to a flight plan over a mapped area via the planning module 710. The map of the mapped area may also be stored in and retrieved from the route plan database 720. It is noted that the route plan may be configured to provide a predefined “band” (area or region where operation is permissible) within with the aerial vehicle 110 is controlled through the remote controller 120.

The route check module 730 may be configured to conduct a check of the desired route to evaluate potential issues with the route planned. For example, the route check module 730 may be configured to identify particular factors such as terrain elevation that may be challenging for the aerial vehicle 110 to clear. The route check module 730 may check environment conditions along the planned route to provide information on potential challenges such as wind speed or direction.

The route check module 730 may also retrieve data from the avoidance database 740 for use in checking a particular planned route. The data stored in the avoidance database 740 may include data such as flight related restriction in terms of areas and/or boundaries for flight (e.g., no fly areas or no fly beyond a particular boundary (aerial restrictions)), altitude restrictions (e.g., no fly above a ceiling of some predefined altitude or height), proximity restrictions (e.g., power lines, vehicular traffic conditions, or crowds), and/or obstacle locations (e.g., monuments and/or trees). The data retrieved from the avoidance database 740 may be used to compare against data collected from the sensors on the aerial vehicle 110 to see whether the collected data corresponds with, for example, a predefined condition and/or whether the collected data is within a predetermined range of parameters that is within an acceptable range of error.

The route check module 730 also may include information corresponding to where the aerial vehicle 110 can or cannot set down. For example, the route check module 730 may incorporate information regarding where the aerial vehicle 110 cannot land (“no land zone”), such as, highways, bodies of water (e.g., a pond, stream, rivers, lakes, or ocean), and/or restricted areas. Some retrieved restrictions may be used to adjust the planned route before flight so that when the plan is uploaded into the aerial vehicle 110 a user is prevented from flying along a particular path or in a certain area (e.g., commands input by the user into the remote controller 120 are overridden by the remote controller 120 or the aerial vehicle 110). Other retrieved restriction data from the avoidance database 740 may be stored with the route plan and also may be uploaded into the aerial vehicle 110 for use during the flight by the aerial vehicle 110. The stored restriction data may be used to make route adjustments when detected, e.g., via the system check module 750 described below.

Referring back to the route check module 730, it also may be configured to alter or provide recommendations to alter the route plan to remove conditions in the flight plan path that may not be conducive for the aerial vehicle 110 to fly through. The altered path or suggested path may be displayed through the planning module 710 on the screen 170 of the remote controller 120. The revised route may be further modified if so desired and checked again by the route check module 730 in an iterative process until the route is shown as clear for flight of the aerial vehicle 110.

The system check module 750 may be configured to communicate with the aerial vehicle 110, e.g., through the communication subsystem 670. The system check module 750 may receive data from the aerial vehicle 110 corresponding to conditions of the aerial vehicle 110 or the surroundings within which the aerial vehicle 110 is operating. The system check module 750 may interface with the planning module 710 and route check module 730 to make route adjustments for the aerial vehicle 110 as it operates and moves along the planned route.

The planning module 710, and in some embodiments the route check module 730, also may interface with the return factors database 760. The return factors database 760 may store return related data corresponding to when the aerial vehicle 110 should return to a predefined spot. This data may be stored with the route plan and uploaded into the aerial vehicle 110. The data also may be used by the system check module 750 to trigger an action for the aerial vehicle 110 to fly to the return location. The return data may be data related to the aerial vehicle 110, such as battery power (e.g., return if battery power is below a predefined threshold that would prevent return of the aerial vehicle 110) or a mechanical condition (e.g., rotor engine stall, burnout, and/or another malfunction). The return data also may be environment data (e.g., wind speed in excess of a predefined threshold) and/or terrain data (e.g., tree density beyond predefined threshold). The return location may be predefined through the planning module 710 by providing, for example, GPS coordinates. Alternately, it may be the location of the remote controller 120. The aerial vehicle 110 may be configured to set down at or near its current location if the system check module 750 determines that the aerial vehicle 110 will not be able to return to the predefined location in view of the return data information received.

It is noted that the databases 720, 740, 760 of the system 705 may be updated and/or augmented. For example, where there may be a local WLAN (e.g., Wi-Fi) or cellular data connection, e.g., through the I/O subsystem 630, the data gathered from sources such as the internet may be used to update the route plan database 720, the avoidance database 740, and the return factors database 760. Moreover, with such data communication, the databases may be updated in real-time so that information may be updated and utilized during flight. Further, the updated data may be transmitted to the communication subsystem 360 of the aerial vehicle 110 in real-time to update the route plan or return path information (further described below) as it becomes available.

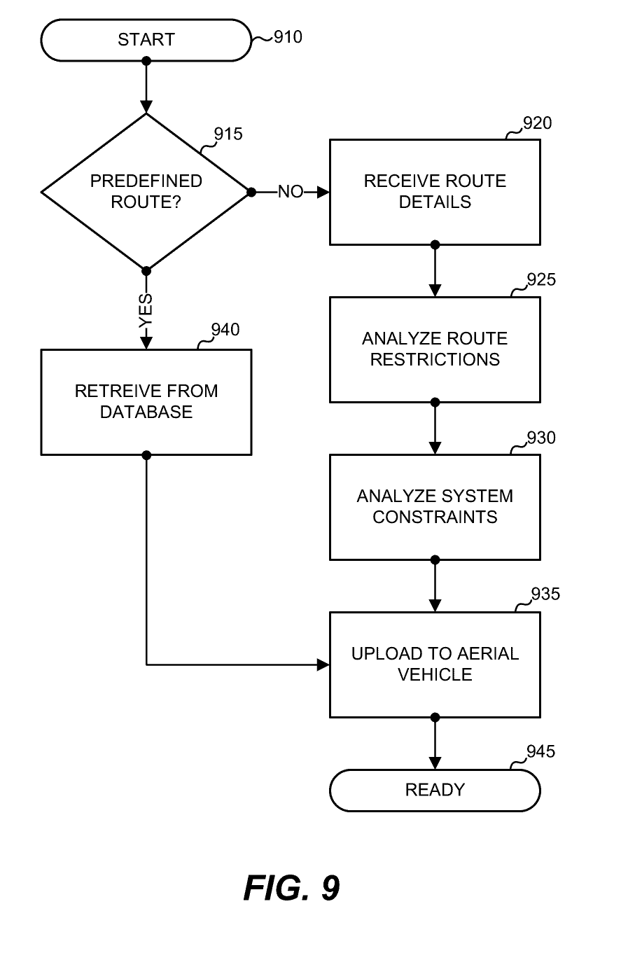

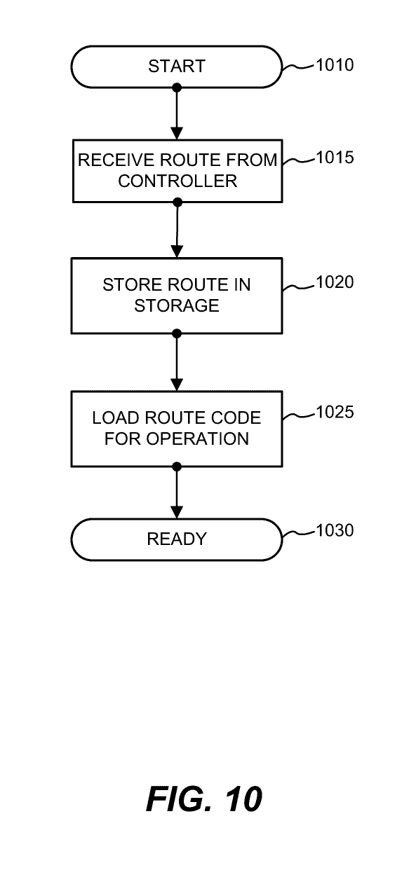

Additional examples of route plan related configurations on a remote controller 120 are described with FIGS. 9 and 10. FIG. 9 illustrates a flow diagram for an example route plan programmed on a remote controller 120. The process may start 910 with the remote control system 605 determining 915 whether there is pre-defined flight route (or path). If not, the process may receive flight route details 920 using, for example, the planning module 710 and route planning database 720. The process analyzes 925 route restrictions using, for example, the route check module 730 and avoidance database 740. The process also may analyzes 930 system constraints through, for example, the avoidance database and system check module 750 (e.g., battery life left on aerial vehicle 110). The process may upload 935 the route details to the aerial vehicle 110. The route also may be stored in the route plan database 720 before being ready for the next actions 945.

If the process determines 915 that a predefined route will be used, that route plan may be retrieved from the route plan database 720. The retrieved route plan may be uploaded 935 to the aerial vehicle 935. If adjustments are made to the retrieved route plan, the process may undertake the steps of analyzing 925 the route restrictions and analyzing 930 the system constraints before being uploaded 935 to the aerial vehicle 110. The processes of analyzing 925, 930 may be iterative before upload 935 and before being ready 945 for the next actions.

Turning to FIG. 10, it illustrates a flow diagram for an example program load operation onto the aerial vehicle 110. The process may start 1010 with the flight controller 315 processing subsystem receiving 1015 the route information from the remote controller 120. The received route information may be stored 1020 in a storage (e.g., memory and/or flash storage). When ready for execution, the process may retrieve the stored route information and load 1025 the route information and/or corresponding executable code for execution by the flight controller 315 processing subsystem. Subsequent to this, the aerial vehicle 110 may be ready 1030 for flight using the loaded route information.

### Example Flight Control System for Aerial Vehicle

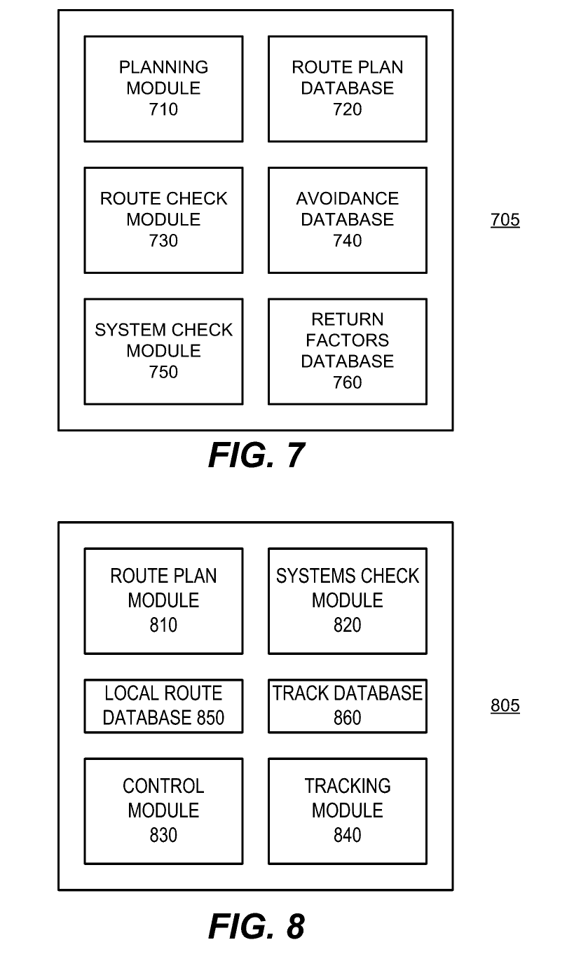

Turning now to FIG. 8, it illustrates a functional block diagram of an example flight control system 805 for a remote controlled aerial vehicle, e.g., aerial vehicle 110. The flight control system 805 may include a route plan module 810, a systems check module 820, a control module 830, tracking module 840, a local route database 850, and/or a tracking database 860.

It is noted that the modules of the flight control system 805 may be embodied as software (including firmware). The software may be program code (or software instructions) stored in a storage medium and executable by the flight controller 315 processing subsystem.

The route plan module 810 may be configured to execute the route plan for the aerial vehicle 110. The route plan may be one uploaded from the remote controller 120 as described in conjunction with FIG. 10. The route plan may be transmitted via the communication subsystem 670 of the remote controller 120 and received by the communication subsystem 360 of the aerial vehicle 110. The route plan may be configured to provide a predefined “band” within which the aerial vehicle 110 is controlled. The systems check module 820 may be configured to monitor operational systems of the aerial vehicle 110 and flight environment and terrain sensor data captured by the aerial vehicle 110 when in operation. The operational systems information may include information related to flight of the aerial vehicle 110, for example, remaining battery power, mechanical operation, and/or electrical operation. Flight environment and terrain sensor data may correspond to data from the sensor subsystem 335 of the aerial vehicle 110, for example, temperature, moisture, wind direction, object detection, altitude, and/or direction (e.g., heading) data.

The control module 830 may be configured to control operation of the aerial vehicle 110 when it is in flight. The control module 830 may be configured to receive control commands from the remote controller 120. The received commands may be, for example, generated via the control panels 150, 155 and transmitted from the communication subsystem 670 of the remote controller 120 for receiving and processing at the aerial vehicle 110 via its communication subsystem 360 and flight controller 315. The received commands may be used by the control module 830 to manipulate the appropriate electrical and mechanical subsystems of the aerial vehicle 110 to carry out the control desired.

The control module 830 also may interface with the route plan module 810 and the systems check module 820 to ensure that the controls executed are within the permissible parameter of the route (or path) provided by the route plan module 810. Further, when an aerial vehicle 110 is in flight, there may be instances in which early detection of potential problems may be beneficial so that course (including flight) modifications can be taken when necessary and feasible. The control module 830 also may make course changes in view of receiving information from the systems check module 820 that may indicate that such course correction is necessary, for example, to navigate around an object detected by the sensor subsystem 335 and/or detected and analyzed by the camera 230. Other example course changes may occur due to wind levels exceeding a threshold at a particular altitude so that the aerial vehicle 110 may move to a lower altitude where wind may be less of an issue despite the control information received from the remote controller 120. In making these changes, the control module 830 may work with the tracking module 860 to update the local route database 850 to identify locations of objects or identify areas of flight that would be identified for avoidance for other reasons (e.g., weather conditions and/or electronic interference) for tracking by the tracking module 840 and for later upload to an avoidance database, e.g., avoidance database 740.

The tracking module 840 may be configured to track the flight of the aerial vehicle 110 (e.g., data corresponding to “clear” path of flying). The tracking module 840 also may store this information in the track database 860 and/or may store information in the local route database 850. The tracking module 840 may be used to retrieve the route the aerial vehicle 110 actually took and use that data to track back to a particular location (e.g., the return location). This may be of particularly interest in situations in which the aerial vehicle 110 needs to be set down (e.g., land) as quickly as possible and/or execute a return path. For example, if the systems check module 820 detects an impending power, electrical, and/or mechanical issue that may affect further flying of the aerial vehicle 110, it may instruct the control module 830 to configure itself into an override mode. In the override mode, the control module 830 may limit or cut off the control information received from the remote controller 120. The control module 830 may retrieve a return path from the tracking module 840 for the aerial vehicle 110 to identify a location where the aerial vehicle 110 can be set down as quickly as possible based on data from the systems control module 820, e.g., amount of battery power remaining and/or execute a return path. For example, upon executing a return path, the control module 830 may determine that the battery power left does not allow for return to a predefined location and determine that the aerial vehicle 110 may instead need to land somewhere along the clear path.

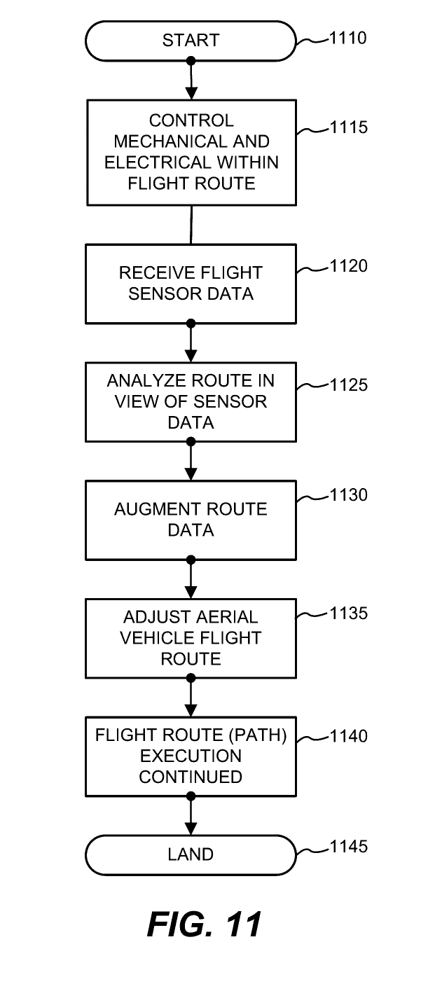

FIG. 11 provides an example of additional details for flight control operation on the aerial vehicle 110. In particular, FIG. 11 illustrates a flow diagram for an example program path operation on the remote controlled aerial vehicle 110. The process may start 1110 with control information being received from the remote controller 120 through the communication subsystem 360 of the aerial vehicle 110. The control information may be processed by the flight controller 315 to control 1115 the mechanical and electrical components of the aerial vehicle 110 within the context of the programmed flight route. The sensor subsystem 335 may receive 1120 flight data information from sensors on board the aerial vehicle 110. This sensor data may include an orientation of the aerial vehicle 110 detected by the UAV compass 337. This data may be analyzed 1125 by the systems check module 820. The control module 830 may augment 1130 the analyzed data based on other information to modify the route, e.g., detection of an object by the sensor subsystem 335 and/or image analysis of an image captured by the camera 230. In such instances, the aerial vehicle 110 flight route may be adjusted 1135 by the control module 830. When the flight route is completed 1140, the aerial vehicle 110 may continue to fly within the parameters of system operation and flight route (or path) until the aerial vehicle 110 has landed 1145. It is noted that the aerial vehicle 110 may be configured not to land within locations predefined as “no land zones.” In such situations, a user of the remote controller 120 may continue to fly the aerial vehicle 110 to an area where landing 1145 is permitted.

### Example Return Path Operation on Aerial Vehicle

As noted previously, there may be instances in which the aerial vehicle 110 may need to execute a return path. For example, operational conditions on the aerial vehicle 110 or a signal of return to home from the remote controller 120 may trigger a return path. On the aerial vehicle 110, the route plan module 810, control module 830 and/or tracking module 840 may be configured to provide a return path. The return path may have been preprogrammed from the flight plan, but thereafter modified with information picked up during flight of the aerial vehicle 110 and stored during flight. For example, during flight, the sensors on the aerial vehicle 110 may detect obstacles that should be avoided that obstruct the pre-programmed return path. A detected obstacle and/or corresponding location data (e.g., GPS coordinates or points) of that obstacle may be stored in the local route database 850. The route plan module 810, control module 830, and/or tracking module 840 may execute a return path operation on the aerial vehicle 110. The return path operation may include retrieving the return path program, extracting data corresponding to obstacles (or other avoidance data) determined to be in the return path that were detected and stored during flight, revising the return path program to adjust for those obstacles (e.g., changes route to clear object), and/or executing the modified return path so that the obstacles are avoided on the return path.

The disclosed configuration may beneficially implement an intelligent return to home behavior for the aerial vehicle 110. The return to home configuration may use a return path that is a direct path from a current location to a predefined location. Alternately, or in addition, the direct route may incorporate obstacle avoidance. By way of example, assume during flight the aerial vehicle 110 flies around a tree. This data (e.g., location data) may be stored in the aerial vehicle 110. Later, if a “return to home” (or “come home”) button is selected on the remote controller 120, the aerial vehicle 110 return path may track back along the direct route while avoiding the tree, which is identified as an obstacle. Hence, the disclosed configuration return path may track back along what may be a clear path on the way back because such path avoided obstacles. In addition, the clear path may be direct path from a current location to a predetermined location (e.g., an initial take off location and/or initial location where data was captured) and may avoid redundant points along the route (e.g., multiple passes around a tree or building). The clear path may be saved within the aerial vehicle 110. In addition, if the UAV compass 337 is automatically-calibrated prior to flight as previously described, the return path executed may be capable of automatic guidance along a path that should correspond to the expected directional path. In some example embodiments, in addition to obstacle avoidance, the return path program may use a direct route back to the predefined location to land or a place to land along that route that is determined to be clear. Landing at a place other than the predefined location may be due to other factors coming into consideration, for example, if battery power is insufficient to return to predefined location or mechanical integrity would prevent return to predefined location.

The disclosed configuration may reduce or remove aspects of flight behavior of the aerial vehicle 110 that would be unnecessary for a return path. For example if the aerial vehicle 110 flew several loops around a tree, it may be undesirable to backtrack all of the loops when on a return path. Accordingly, the aerial vehicle 110 may be configured to mark areas as “clear” (i.e., areas that are clear may then be identified through “clear breadcrumbs”) as the aerial vehicle 110 is in flight. The clear path may be generated, for example, by removing location data (e.g., GPS) of the tracked flight path that may be redundant and/or accounting for obstacle data that may have been collected so as to avoid those obstacles. Further, it may be a direct flight path from a current location of the aerial vehicle to a predetermined location (e.g., initial take off location). The data corresponding to “clear” may be assembled into a graph for use in a return path. Thereafter, if the aerial vehicle 110 needs to come back (e.g., execute a return path) to the starting location, the aerial vehicle 110 may take the shortest path through the graph of the cleared areas. This information may be stored and used through the control module 830 and/or the tracking module 840. Hence, if the aerial vehicle 110 flew a path with several loops and figure eights and this path self-intersects, the control module 840 may make connections at those intersections, build a graph corresponding to the intersections in that flight, and take a shortest path through cleared area back to a return location, for example, by removing redundant location data collected along the flight path. The process also may use an initial take off location of the aerial vehicle 110 (e.g., where the aerial vehicle 100 started flying from) as the return location.

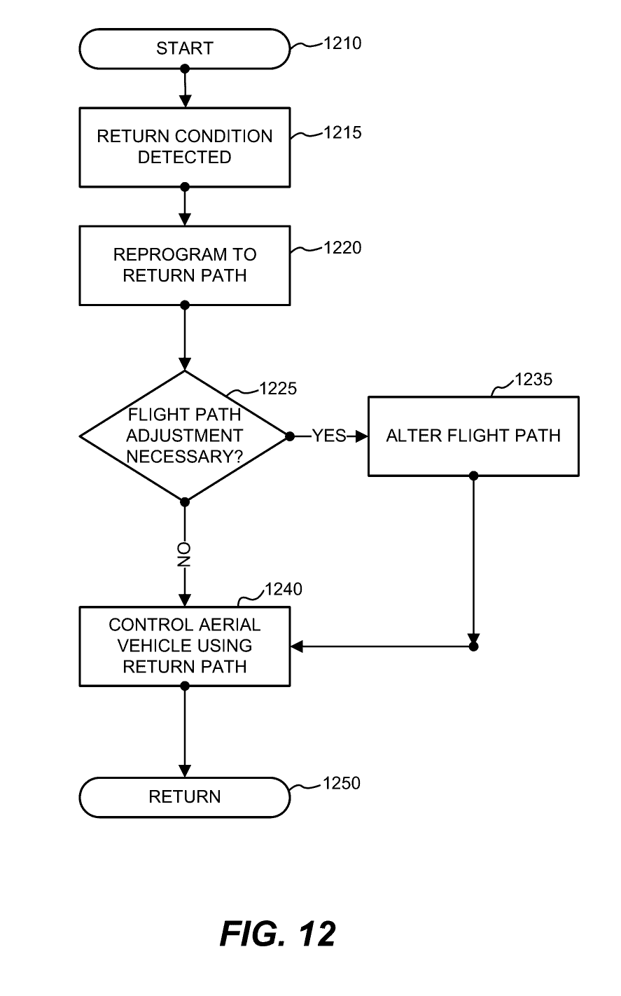

FIG. 12 illustrates a flow diagram for an example return path operation on a remote controlled aerial vehicle 110. The return path may be executed due to voluntary action, e.g., user selection of the return button 165 on the remote controller 120, or through involuntary action. Involuntary actions may include system related issue on the aerial vehicle 110, for example, low battery power, mechanical issues, and/or electrical issues. The involuntary actions may also be triggered by sources such as location information or environmental information such as flying in a defined boundary or area, weather and climatic issues (e.g., wind and/or precipitation), and/or physical considerations such as object density (e.g., the density of trees in a geographic area). The aerial vehicle 110 monitoring may be set up through the return factors database 760 and monitored for triggering of a return condition through the system check module 820, which may work in conjunction with the control module 830 to trigger a return mode.

In this example, the return path operation may start 1210 by detection 1215 of a return condition, for example, the systems check module 820 detecting an impending power, electrical, and/or mechanical issue. The control module 830, in conjunction with the route plan module 810 may trigger a reprogramming 1220 of the aerial vehicle 110 to now follow a return path. The control module 830 may work in conjunction with the route plan module 810, which may have preprogrammed coordinates of a return location. Also, the control module 830 may work in conjunction with the tracking module 840, which may include information on possible return paths accounting for potential obstacles as may have been logged in the track database 860 during flight of the aerial vehicle 110. It is noted that, in some embodiments, the aerial vehicle 110 also may track “clear” areas during flight and store those locations. Thereafter, if a return path is triggered, either manually or automatically, the “cleared” location data points may be retrieved to generate a return flight path that the control module 830 can execute. This configuration may be beneficial, for example, if no return path is programmed or circumstances do not allow for return to a precise return location (e.g., a “home” location).

As the return flight path is executed and the aerial vehicle 110 enters the return mode, the control module 830 may override control information arriving from the remote controller 120 and engage in an auto-pilot to navigate to the location pre-defined with the return to home. If there are flight adjustments 1225, the process may alter the return flight path according to information stored and processed by the tracking module 840, the track database 860, and/or the local route database 850. The control module 830 may be configured to control 1240 the aerial vehicle 110 back to the return location 1250. The return location 1250 may be identified in the route plan module 810 (e.g., the original route plan may include coordinates for a return location), may use the location of the remote controller 120 (e.g., using its GPS location) as a return location, and/or may identify an intermediate location as determined through the local route database 850 and/or the track database 860 in conjunction with the tracking module 840 and the route plan module 810.

It is noted that other operational scenarios also may trigger a return flight path. For example, the systems check module 820 may closely monitor maintenance of a communication link (e.g., wireless link 125) between the communications subsystem 360 of the aerial vehicle 110 and the communication subsystem 670 of the remote controller 120. A loss of a communication link between the communications subsystem 360 of the aerial vehicle 110 and the communication subsystem 670 of the remote controller 120 may trigger a return path. In this example, the system may be configured so that if the communication link has been severed, the systems check module 820 notifies the control module 830 to try to reestablish the communication link. If the communication link is not established within a predefined number of tries or a predefined time period, the control module 830 may trigger the start of the return flight path as described above.

### Remote Controller User Interface Example

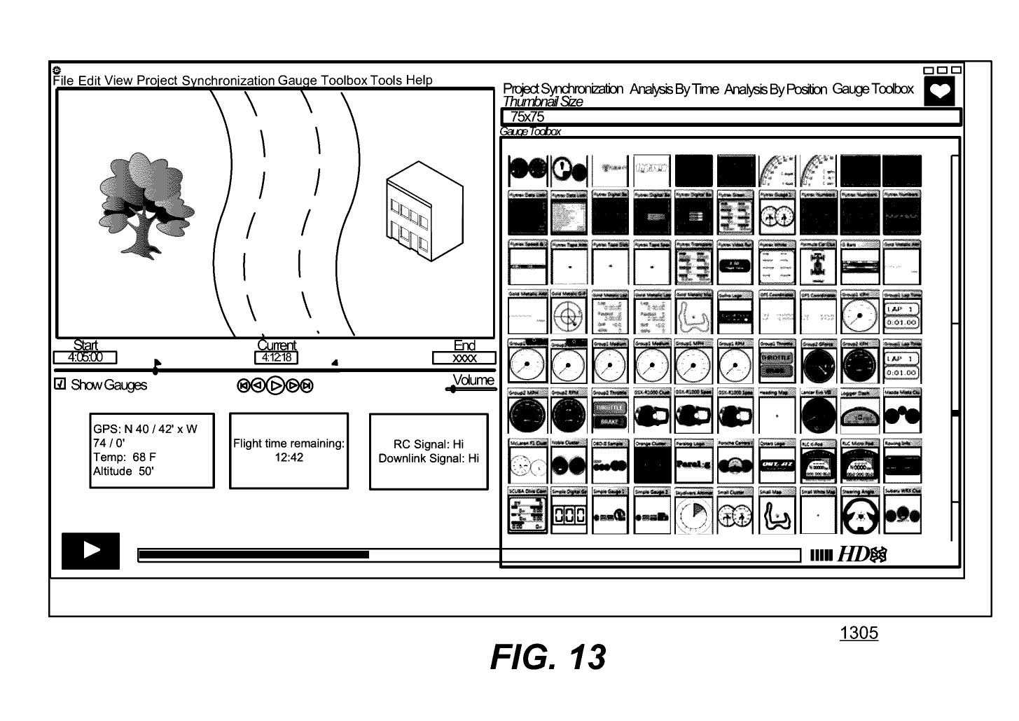

FIG. 13 illustrates an example user interface 1305 for use with the remote controller 120. The user interface 1305 may be configured for display on the screen 170 of the remote controller 120. In this example, the user interface 1305 corresponds to a “dashboard” for the aerial vehicle 110. In one embodiment, the remote controller 120 may receive, e.g., via the I/O subsystem 630 and/or communications subsystem 670, sensor data logged by the sensor subsystem 335 (and transmitted via the communication subsystem 360) of the aerial vehicle 110 as it is in flight. In one example embodiment, the aerial vehicle 110 may incorporate the telemetric (or sensor) data with video that is transmitted back to the remote controller 120 in real time. The received telemetric data may be extracted from the video data stream and incorporate into predefine templates for display with the video on the screen 170 of the remote controller 120. The telemetric data also may be transmitted separate from the video from the aerial vehicle 110 to the remote controller 120. Synchronization methods such as time and/or location information may be used to synchronize the telemetric data with the video at the remote controller 120. This example configuration may allow a user, e.g., operator, of the remote controller 120 to see where the aerial vehicle 110 is flying along with corresponding telemetric data associated with the aerial vehicle 110 at that point in the flight. Further, if the user is not interested in telemetric data being displayed real-time, the data may still be received and later applied for playback with the templates applied to the video.

The predefine templates may correspond to “gauges” that provide a visual representation of speed, altitude, and charts, e.g., as a speedometer, altitude chart, and a terrain map. The populated templates, which may appear as gauges on screen 170 of the remote controller 120, may further be shared, e.g., via social media, and/or saved for later retrieval and use. For example, a user may share a gauge with another user by selecting a gauge (or a set of gauges) for export. Export may be initiated by clicking the appropriate export button, or a drag and drop of the gauge(s). A file with a predefined extension may be created at the desired location. The gauge may be selected and be structured with a runtime version of the gauge or may be played back through software that can read the file extension.

### Example Machine Architecture

As has been noted, the remote controlled aerial vehicle 110 may be remotely controlled by the remote controller 120. The aerial vehicle 110 and the remote controller 120 may be machines that may be configured to operate using software. FIG. 13 is a block diagram illustrating components of an example machine able to read instructions from a machine-readable medium and execute them in one or more processors (or controllers). All or portions of the example machine described in FIG. 14 may be used with the aerial vehicle 110 and/or the remote controller 120 and/or other parts of a system that interfaces with the aerial vehicle 110 and/or remote controller 120.

In FIG. 14, there is a diagrammatic representation of a machine in the example form of a computer system 1400. The computer system 1400 may be used to execute instructions 1424 (e.g., program code or software) for causing the machine to perform any one or more of the methodologies (or processes) described herein. In some embodiments, the machine may operate as a standalone device or a connected (e.g., networked) device that connects to other machines. In a networked deployment, the machine may operate in the capacity of a server machine or a client machine in a server-client network environment, or as a peer machine in a peer-to-peer (or distributed) network environment.

The machine in this example may be a handheld controller (e.g., remote controller 120) to control the remote controlled aerial vehicle 110. The architecture described also may be applicable to other computer systems that operate in the system of the remote controlled aerial vehicle 110 with camera and mounting configuration, e.g., in setting up a local positioning system. These other example computer systems may include a server computer, a client computer, a personal computer (PC), a tablet PC, a smartphone, an internet of things (IoT) appliance, a network router, switch or bridge, and/or any machine capable of executing instructions 1424 (sequential or otherwise) that specify actions to be taken by that machine. Further, while only a single machine is illustrated, the term “machine” may also refer to include any collection of machines that individually or jointly execute instructions 1424 to perform any one or more of the methodologies discussed herein.

The example computer system 1400 includes one or more processing units (generally processor 1402). The processor 1402 may be, for example, a central processing unit (CPU), a graphics processing unit (GPU), a digital signal processor (DSP), a controller, a state machine, one or more application specific integrated circuits (ASICs), one or more radio-frequency integrated circuits (RFICs), and/or any combination of these. The computer system 1400 also may include a main memory 1404. The computer system 1400 may include a storage unit 1416. The processor 102, memory 1404 and/or the storage unit 1416 may communicate via a bus 1408.

In addition, the computer system 1400 may include a static memory 1406, a display driver 1410 (e.g., to drive a screen (e.g., screen 170) such as a plasma display panel (PDP), a liquid crystal display (LCD), and/or a projector). The computer system 1400 may also include input/output devices, e.g., an alphanumeric input device 1412 (e.g., a keyboard), a dimensional (e.g., 2-D or 3-D) control device 1414 (e.g., a mouse, a trackball, a joystick, a motion sensor, and/or other pointing instrument), a signal generation device 1418 (e.g., a speaker), and/or a network interface device 1420, which also may be configured to communicate via the bus 1408.

The storage unit 1416 may include a machine-readable medium 1422 on which is stored instructions 1424 (e.g., software) embodying any one or more of the methodologies or functions described herein. The instructions 1424 also may reside, completely or at least partially, within the main memory 1404 or within the processor 1402 (e.g., within a processor's cache memory) during execution thereof by the computer system 1400. The main memory 1404 and the processor 1402 also may constitute machine-readable media. The instructions 1424 may be transmitted or received over a network 1426 via the network interface device 1420.

While the machine-readable medium 1422 is shown in the example embodiment depicted in FIG. 14 to be a single medium, the term “machine-readable medium” may refer to a single medium or multiple media (e.g., a centralized database, a distributed database, and/or associated caches and servers) able to store the instructions 1424. The term “machine-readable medium” may also refer to any medium that is capable of storing instructions 1424 for execution by the machine and that cause the machine to perform any one or more of the methodologies disclosed herein. The term “machine-readable medium” may include, but is not limited to, data repositories in the form of solid-state memories, optical media, and magnetic media.

### ADDITIONAL CONSIDERATIONS

The disclosed configuration may beneficially execute the detection of conditions in an aerial vehicle that automatically triggers a return path for having the aerial vehicle return and/or set down in a predefined location. Moreover, the disclosed configurations also may apply to other vehicles to automatically detect and trigger a return path.

Throughout this specification, plural instances may implement components, operations, or structures described as a single instance. Although individual operations of one or more methods may be illustrated and described as separate operations, one or more of the individual operations may be performed concurrently. The operations may not be required to be performed in the order illustrated. Structures and functionality presented as separate components in example configurations may be implemented as a combined structure or component. Similarly, structures and functionality presented as a single component may be implemented as separate components. These and other variations, modifications, additions, and improvements may fall within the scope of the subject matter herein.

Certain embodiments are described herein as including logic or a number of components, modules, or mechanisms, for example, as illustrated in FIGS. 3-12. Modules may constitute either software modules (e.g., code embodied on a machine-readable medium or in a transmission signal), hardware modules, or a combination of hardware and software. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

The various operations of example methods described herein may be performed, at least partially, by one or more processors, e.g., processor 1402, that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, include processor-implemented modules.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of some of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may refer to self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It may be convenient at times, principally for reasons of common usage, to refer to such signals using words such as “data,” “content,” “bits,” “values,” “elements,” “symbols,” “characters,” “terms,” “numbers,” and/or “numerals.” These words, however, are merely convenient labels and are to be associated with appropriate physical quantities.

Unless specifically stated otherwise, discussions herein using words such as “processing,” “computing,” “calculating,” “determining,” “presenting,” and/or “displaying” may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, and/or apparatus that comprises a list of elements may not necessarily limited to only those elements but may include other elements not expressly listed or inherent to such process, method, article, or apparatus. Further, unless expressly stated to the contrary, “or” may refer to an inclusive or rather than to an exclusive or. For example, a condition A or B may be satisfied by any one of the following: A is true (or present) and B is false (or not present), A is false (or not present) and B is true (or present), and both A and B are true (or present).

In addition, use of the “a” or “an” are employed to describe elements and components of the embodiments herein. This may be done merely for convenience and to give a general sense of the invention. This description should be read to include one or at least one and the singular also includes the plural unless it is obvious that it is meant otherwise.

Upon reading this disclosure, those of skill in the art may appreciate still additional alternative structural and functional designs for a system and a process for automatically detecting and executing a return path for a vehicle through the disclosed principles herein. Thus, while particular embodiments and applications have been illustrated and described, it is to be understood that the disclosed embodiments are not limited to the precise construction and components disclosed herein. Various modifications, changes and variations, which may be apparent to those skilled in the art, may be made in the arrangement, operation and details of the method and apparatus disclosed herein without departing from the spirit and scope defined in the appended claims.

What is claimed is:

1. A method to automatically calibrate a compass of an aerial vehicle, the method comprising:
rotating a gimbal coupled with the aerial vehicle to a plurality of angular rotations;
measuring a magnetic field, with a gimbal compass of the gimbal, at the plurality of angular rotations to obtain a plurality of measurements;
calculating a calibration value for the gimbal compass based on the measurements;
transferring the calibration value to the aerial vehicle;
adding a calibration difference value to the calibration value to obtain a current calibration value for the aerial vehicle; and
storing the current calibration for use with the compass of the aerial vehicle.

2. The method of claim 1, wherein the calibration difference value is a factory-calculated calibration value.

3. The method of claim 1, wherein the calibration difference value is a user-defined calibration value.

4. The method of claim 1, wherein the aerial vehicle transmits a signal to a remote controller indicating completion of the automatic calibration.

5. The method of claim 1, wherein the aerial vehicle illuminates an LED as an indication of completion of the automatic calibration.

6. The method of claim 1, wherein the aerial vehicle determines its orientation based on a measurement with the compass of the aerial vehicle and based on the current calibration.

7. A method to automatically calibrate a compass of an aerial vehicle, the method comprising:
powering up an aerial vehicle;
rotating a gimbal coupled with the aerial vehicle in a wide range of angular rotations;
calibrating, in response to the rotations, a gimbal compass of the gimbal to obtain a calibration value, the gimbal compass including a magnetometer;
transferring the calibration value to the aerial vehicle;
adding a calibration difference value to the calibration value to obtain a current calibration value for the aerial vehicle; and
storing the current calibration for use with the compass of the aerial vehicle.

8. The method of claim 7, wherein the calibration difference value is a factory-calculated calibration value.

9. The method of claim 7, wherein the calibration difference value is a user-defined calibration value.

10. The method of claim 7, wherein the aerial vehicle transmits a signal to a remote controller indicating completion of the automatic calibration.

11. The method of claim 7, wherein the aerial vehicle illuminates an LED as an indication of completion of the automatic calibration.

12. The method of claim 7, wherein the aerial vehicle determines its orientation based on a measurement with the compass of the aerial vehicle and based on the current calibration.

13. A computer readable storage medium comprising stored instructions to automatically calibrate a compass of an aerial vehicle, the instructions when executed by a processor cause the processor to:
power up an aerial vehicle;
rotate a gimbal coupled with the aerial vehicle in a wide range of angular rotations;
calibrate, in response to the rotations, a gimbal compass of the gimbal to obtain a calibration value, the gimbal compass including a magnetometer;
transfer the calibration value to the aerial vehicle;
add a calibration difference value to the calibration value to obtain a current calibration for the aerial vehicle; and
store the current calibration for use with the compass of the aerial vehicle.

12. The computer readable storage medium of claim 13, wherein the calibration difference value is a factory-calculated calibration value.

13. The computer readable storage medium of claim 13, wherein the calibration difference value is a user-defined calibration value.

14. The computer readable storage medium of claim 13, further comprising stored instructions that when executed by the processor causes the processor to transmit a signal to a remote controller indicating completion of the automatic calibration.

15. The computer readable storage medium of claim 13, further comprising stored instructions that when executed by the processor causes the processor to illuminate an LED as an indication of completion of the automatic calibration.

16. The method of claim 13, wherein the aerial vehicle determines its orientation based on a measurement with the compass of the aerial vehicle and based on the current calibration.
